(19) United States
(12) Patent Application Publication
(10) Pub. No.: US 2006/0047799 A1
(43) Pub. Date: Mar. 2, 2006

(54) Model-based operation support systems and related methods

(76) Inventor: Matthias Bannach, Setauket, NY (US)

Correspondence Address: HARNESS, DICKEY & PIERCE, P.L.C., P.O. Box 8910, Reston, VA, 20195, US

(21) Appl. No.: 10/923,798

(22) Filed: Aug. 24, 2004

(51) Int. Cl. G06F 15/173

(52) U.S. Cl. 709/223

(57) ABSTRACT

Model-based operation support systems (OSSs) use generalized, normalized models capable of recognizing changes, etc., to any number of different network elements. The ability to recognize changes, modifications and extensions made to various network elements helps reduce the costs associated with OSSs.

### BACKGROUND OF THE INVENTION

Co-pending U.S. patent application Ser. No. ______, the disclosure of which is incorporated herein as if set forth in full herein, discusses the use of mediation units to transform changes made to models used by a number of different network elements (i.e., a device that is a part of a managed network that carries data across the network or processes data) into one or more forms of data, referred to as normalized meta-data, which is recognized by an operation support system (OSS). The transformations are aided by the use of transformation models stored in meta-data libraries, such as those disclosed in co-pending U.S. patent application Ser. No. ______, the disclosure of which is incorporated herein as if set forth in full herein.

Existing OSSs are not capable of recognizing the normalized meta-data or related definitions which are sent from a mediation unit after using transformation models stored in a meta-data library.

Accordingly, it is therefore desirable to provide OSSs which are capable of recognizing the normalized meta-data and related definitions that are created by mediation units disclosed in co-pending U.S. patent application Ser. No. ______ based on models stored in meta-data libraries disclosed in co-pending U.S. patent application Ser. No. ______.

### SUMMARY OF THE INVENTION

We have recognized that operation support systems that are capable of recognizing normalized meta-data and related definitions, etc. can be provided by creating model-based OSSs. One model-based OSS comprises: a model storage section operable to store a normalized model; a life-cycle section operable to update and maintain the normalized model based on normalized meta-data and definitions relating to changes to one or more network element models; and a management section, operable to manage the one or more network elements, based on the updated normalized models.

The changes may include modifications or extensions to the models used by the various network elements.

The ability to receive (or retrieve) modifications and extensions to models used by network elements gives model-based OSSs provided by the present invention the ability to evolve as the network elements they are responsible for managing evolve without affecting the management sections of the OSS.

### BRIEF DESCRIPTION OF THE DRAWINGS

FIG. 1 depicts a simplified block diagram of a network which includes a model-based OSS according to one embodiment of the present invention.

### DETAILED DESCRIPTION OF THE INVENTION

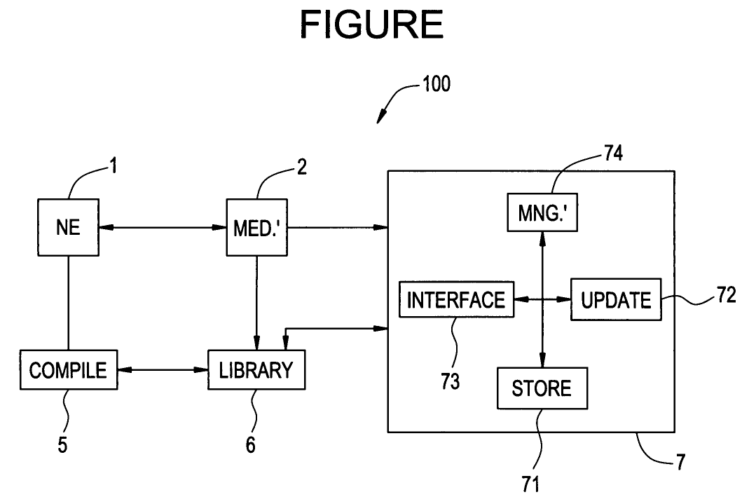

Referring to FIG. 1, there is shown a network 100 which includes a model-based OSS 7 according to one embodiment of the present invention. Shown connected to OSS 7 is a meta-data library 6 and mediation unit 2. The OSS 7 is operable to receive normalized meta-data and definitions (e.g., meta-meta data definitions) relating to changes, modifications, or extensions to models used by one or more network elements 1 via the mediation unit 2 or meta-data library 6. As indicated above, the operation of mediation unit 2 and meta-data library 6 is discussed in more detail in co-pending U.S. patent application Ser. Nos. ______ and ______, respectively.

In general, the combination of mediation unit 2 and meta-data library 6 generates a set of normalized meta-data and definitions which is, for example, sent to the OSS 7 from mediation unit 2. The meta-data and definitions represent changes, modifications or extensions to one or more network elements 1. Before going further, it should be understood that though the components shown in FIG. 1 are shown as individual units, they may be combined into fewer units or broken down further into additional units. For example, network element 1 may in actuality comprise a plurality of network elements such as servers, routers, multi-protocol layer switched (MPLS) switches, firewalls, proxies, gateways, etc.

Historically, existing OSSs would not be able to recognize the normalized meta-data or definitions generated by the combination of the meta-data library 6 and mediation unit 2. Instead, existing OSSs use any one of a number of standards to analyze changes to network elements. Because each network element 1 may be made by a different vendor or manufacturer, this may require an individual OSS to recognize any number of different models. As explained in more detail in co-pending U.S. patent application Ser. Nos. ______ and ______, this greatly increases the cost of an OSS and in some cases, causes a network operator to abandon the idea of trying to keep up or update an OSS with all of the various changes to different network element models.

In one embodiment of the present invention, the OSSs provided by the present invention use a model-based approach to further reduce the cost of updating OSSs. In this model-based approach, one normalized model is used by an OSS, like OSS 7 in FIG. 1. This normalized model can be looked upon as being a generalized grammar or vocabulary. This normalized model is typically stored in the OSS 7 and the meta-data library 6 and is used by the mediation unit 2 to transform all of the changes to the different models used by network elements into normalized versions which can be recognized and understood by the OSS 7. In sum, one advantage of using a normalized model is, as implied above, that no longer must an OSS be concerned with the type of model being used by a network element. Instead, this task is carried out by the mediation unit 2.

Referring again to FIG. 1, the OSS 7 is shown comprising a model storage section 71, life-cycle section 72, interface section 73, and a management section 74. Again, it should be understood that these sections may be combined into fewer sections or further broken down into additional sections to carry out the features and functions of the present invention described above and below.

One example of how the OSS 7 and its various sections operate is as follows. In one embodiment of the present invention, the model storage section 71 is operable to store a normalized model. At any given point in time, the life-cycle section 72 (e.g., model life-cycle) is operable to receive normalized meta-data and definitions, representing changes to one or more network elements 1, more specifically, to the models used by network elements 1. Upon receiving these changes, the life-cycle section 72 is further operable to update the normalized model stored within the storage section 71 in order to reflect the changes to the models used by the network elements 1. Thereafter, the management section 74 may be operable to manage one or more of the network elements 1 using the normalized model stored in storage section 71 and the various updates to the normalized models. It should be noted that the network elements 1 that are being managed by the OSS 7 are operating using non-normalized models.

In this manner, one OSS 7, may be operable to manage a number of different network elements that are using varied network element models. As the models used by the network elements evolve, so too, does the normalized model stored within the OSS 7.

Up to now we have discussed a scenario where the OSS 7 passively receives changes, modifications or extensions to one or more models used by network elements 1. In a further embodiment of the present invention, the OSS 7 may actively retrieve changes associated with one or more of the models used by the network elements 1 by sending instructions or the like through the mediation unit 2 or meta-data library 6, for example. Thus, at any given time, an operator responsible for managing the network 100 comprising the network elements 1 may proactively obtain those changes, modifications or extensions to the one or more network elements 1. This gives the network operator a powerful tool to ensure that the OSS 7 remains capable of managing the various network elements 1 as they evolve and their associated models change.

It should be noted that the OSS 7 is operable to receive or retrieve the various changes, modifications or extensions through mediation unit 2 or meta-data library 6. To do so, the OSS 7 may make use of the interface section 73 for this task. The interface section 73 may be operable to carry out a number of different functions. In one instance, the interface section 73 may assist the mediation unit 2 in transforming any meta-data or definitions from a non-normalized format into a normalized format recognized by the OSS 7. In other instances, the interface section 73 may receive one or more transformation models from the meta-data library 6 to assist it in these transformations. Unlike previous OSSs, however, it is not necessary to add a new interface to OSS 7 each time a new model is added to a network element 1. Instead, in conjunction with the mediation unit 2 and meta-data library 6, a new transformation model will be generated which can be used to transform meta-data or definitions based on this new model into normalized, meta-data or definitions which can be recognized by the normalized model used by the OSS 7. That said, when new extensions are added to a network element 1, the present invention also provides for the extension of the normalized model stored within the OSS 7. For example, if a network element model is using an Internet protocol (IP) and must convert to a voice-over Internet protocol (VOIP) or an MPLS-like protocol, then the meta-data library 6 in conjunction with the mediation unit 2 is operable to generate a new transformation model making it possible to convert meta-meta data definitions from these new extended models into new, normalized meta-meta data definitions which are recognizable by the OSS 7. This creation of new, normalized meta-meta data definitions may be carried out by the mediation unit 2 in conjunction with the meta-data library 6 or may be carried out within an interface section 73 of the OSS 7. Moreover, because the interface section 73 may be updated with these new meta-meta data definition transformations, the cost of updating an OSS as extensions are added to network elements is greatly reduced when compared with the cost of installing a completely new interface, which is required by existing OSSs. In particular, the upheaval and effort required to complete integration testing, a significant challenge and cost in a rapidly evolving network, are greatly reduced.

Changes that are made to network elements 1 sometimes occur over a relatively short period of time. Realizing this, the present invention provides for OSSs that are operable to receive or retrieve changes made to one or more network elements 1 even if these changes occur over a substantially short period of time because an OSS need only concern itself with changes formatted using one normalized model.

Backtracking somewhat, it was stated above that the normalized model stored within the model storage section 71 may be extended when extensions are made to network elements 1. It should be understood that these extensions may be made in conjunction with the life-cycle section 72 as well as management section 74, for example.

The above discussion has attempted to set forth some examples of model-based OSSs provided by the present invention. The true scope of the present invention is defined by the claims which follow.

We claim:

1. A model-based operation support system (OSS) comprising:
a model storage section operable to store a normalized model;
a life-cycle section operable to update the normalized model based on changes to one or more network element models; and
a management section operable to manage one or more of the network elements using the updated normalized model.

2. The OSS as in claim 1 further comprising an interface section operable to retrieve changes associated with one or more network element models.

3. The OSS as in claim 1 wherein the changes comprise extensions to the one or more network element models.

4. A model-based method for managing a network comprising:
storing a normalized model;
updating the normalized model based on changes to one or more network element models; and
managing one or more of the network elements using the updated normalized model.

5. The method as in claim 4 further comprising retrieving changes associated with one or more network element models.

6. The method as in claim 4 wherein the changes comprise extensions to the one or more network element models.
